(19) United States
(12) Patent Application Publication
(10) Pub. No.: US 2018/0264873 A1
(43) Pub. Date: Sep. 20, 2018

(54) DECORATIVE FILM STRUCTURE AND MANUFACTURING METHOD THEREOF

(71) Applicants: Ju-Chen Chiu, Taipei City (TW); Po-An Lin, Taipei City (TW); Sheng-Hung Lee, Taipei City (TW); Kuo-Nan Ling, Taipei City (TW); Chih-Hua Liu, Taipei City (TW)

(72) Inventors: Ju-Chen Chiu, Taipei City (TW); Po-An Lin, Taipei City (TW); Sheng-Hung Lee, Taipei City (TW); Kuo-Nan Ling, Taipei City (TW); Chih-Hua Liu, Taipei City (TW)

(73) Assignee: COMPAL ELECTRONICS, INC., Taipei City (TW)

(21) Appl. No.: 15/920,466

(22) Filed: Mar. 14, 2018

Related U.S. Application Data
(60) Provisional application No. 62/471,351, filed on Mar. 14, 2017.

(51) Int. Cl. B44C 1/175; B05D 5/06; B05D 3/06

(52) U.S. Cl. CPC B44C 1/1756; B05D 3/067; B05D 5/061

(57) ABSTRACT

A decorative film structure includes a foamed resin layer and a protective resin layer. The protective resin layer is disposed on the foamed resin layer and has a stereoscopic patterned surface relatively far from the foamed resin layer. A manufacturing method of the decorative film structure is also provided.

### CROSS-REFERENCE TO RELATED APPLICATION

This application claims the priority benefit of U.S. provisional application Ser. No. 62/471,351, filed on Mar. 14, 2017. The entirety of the above-mentioned patent application is hereby incorporated by reference herein and made a part of this specification.

### BACKGROUND

### Technical Field

The disclosure relates to a film structure and a manufacturing method thereof more particularly, the disclosure relates to a decorative film structure and a manufacturing method thereof.

### Description of Related Art

Currently, a method of coating a decorative film material on a surface of a target product for embellishment includes a step of performing a wet process, e.g., a paint spraying process. When the decorative film material is sprayed onto the housing of the target product, exhaust gas and waste water are generated, which significantly affects the environment. Besides, it is not easy to form a variety of stereoscopic patterns which provides aesthetics to the target product. Accordingly, the industry has developed a dry process; for instance, the decorative film material having the stereoscopic patterns are transfer-printed onto the housing of the target product through transfer printing. However, the existing transfer printing technique requires the removal of a disposable base material after the decorative film material is transfer-printed onto the housing of the target product, and thus the transfer-printing process is completed. This may still produce waste and is not friendly to the environment.

### SUMMARY

The disclosure provides a decorative film structure with softness and flexibility, with tactile sensation of stereoscopic patterns. Besides, the decorative film structure is friendly to environment because the production of waste may be avoided.

The disclosure provides a manufacturing method of a decorative film structure for manufacturing the above-mentioned decorative film structure.

In an embodiment, a decorative film structure includes a foamed resin layer and a protective resin layer. The protective resin layer is disposed on the foamed resin layer and has a stereoscopic patterned surface relatively far from the foamed resin layer.

According to an embodiment, the decorative film structure further includes an adhesive layer. The adhesive layer is disposed on the foamed resin layer. The foamed resin layer is located between the adhesive layer and the protective resin layer.

According to an embodiment, the decorative film structure further includes an ink layer. The ink layer is disposed on the foamed resin layer and located between the foamed resin layer and the protective resin layer.

According to an embodiment, the protective resin layer is colorless or is colored.

In an embodiment, a manufacturing method of a decorative film structure includes following steps. A foamed resin layer is formed. A liquid protective resin layer is formed on the foamed resin layer. A patterned base material is provided on a surface of the liquid protective resin layer, wherein the surface of the liquid protective resin layer is in direct contact with the patterned base material. A curing process is performed on the patterned base material and the liquid protective resin layer to cure the liquid protective resin layer and form a protective resin layer. The patterned base material is removed to expose a stereoscopic patterned surface of the protective resin layer.

According to an embodiment, the manufacturing method of the decorative film structure further includes: forming an adhesive layer before the foamed resin layer is formed.

According to an embodiment, the step of forming the foamed resin layer includes forming a liquid resin layer on the adhesive layer. A foaming process is performed on the liquid resin layer to form a liquid foamed resin layer. The liquid foamed resin layer is cured to form the foamed resin layer.

According to an embodiment, the curing process includes a thermal curing process or a photo-curing process.

According to an embodiment, the manufacturing method of the decorative film structure further includes: forming an ink layer on the foamed resin layer after the foamed resin layer is formed but before the liquid protective resin layer is formed.

In view of the above, according to the manufacturing method of the decorative film structure, the patterned base material is in direct contact with the surface of the liquid protective resin layer on the foamed resin layer, and the curing process is performed on the patterned base material and the liquid protective resin layer to form the protective resin layer with the stereoscopic patterned surface. According to the related art, the disposable base material need be removed after the decorative film material is transfer-printed; by contrast, the manufacturing method of the decorative film structure provided herein is simplified, and the production of waste may be avoided. Hence, the decorative film structure provided herein is friendly to environment. Moreover, the decorative film structure formed by applying the manufacturing method described herein is characterized by softness and flexibility, with visual and tactile sensation of stereoscopic patterns.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A to FIG. 1H are schematic cross-sectional views illustrating a manufacturing method of a decorative film structure according to an embodiment of the invention.

FIG. 2 is a schematic cross-sectional view illustrating adhesion of the decorative film structure depicted in FIG. 1H to a target object.

FIG. 3 is a schematic cross-sectional view of a decorative film structure according to another embodiment of the invention.

FIG. 4 is a schematic cross-sectional view of a decorative film structure according to still another embodiment of the invention.

### DESCRIPTION OF THE EMBODIMENTS

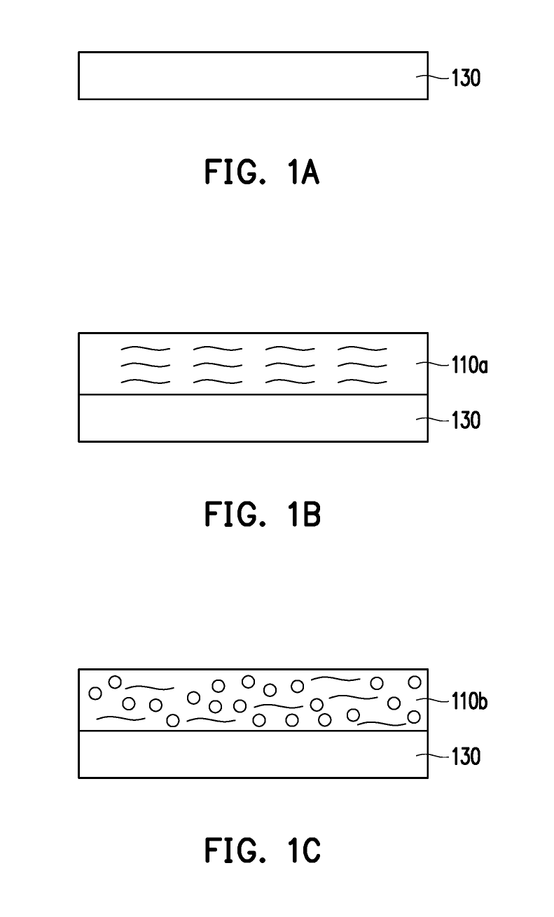

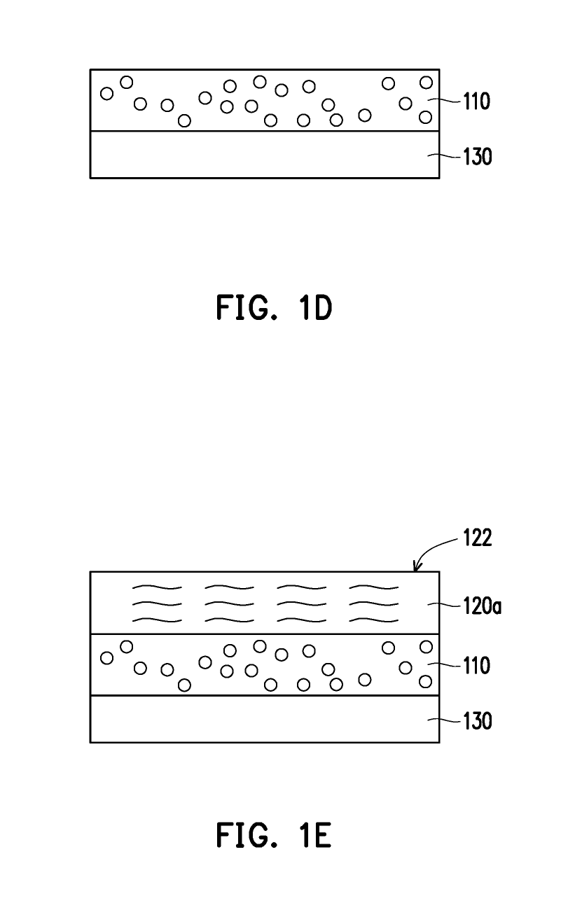

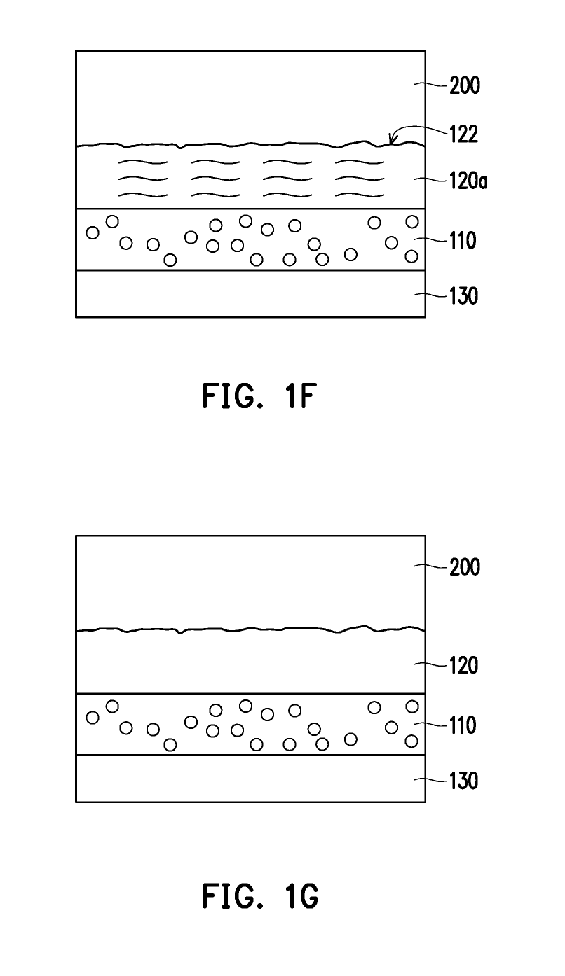

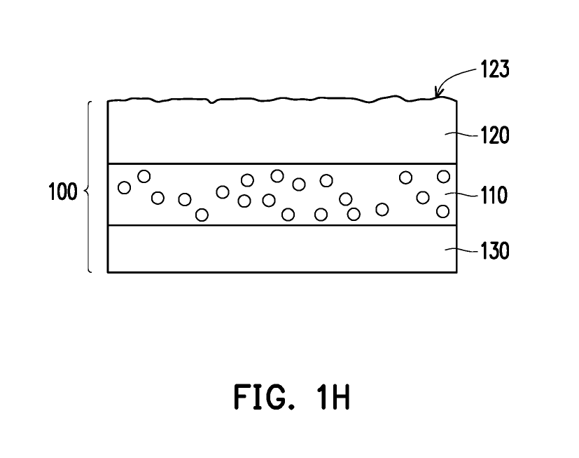

FIG. 1A to FIG. 1H are schematic cross-sectional views illustrating a manufacturing method of a decorative film structure according to an embodiment of the invention. For clarity and ease of reference, the thickness or the proportion of each layer depicted in FIG. 1A to FIG. 1H is adequately enlarged or reduced and does not represent the actual thickness or proportion of each layer. With reference to FIG. 1A, according to the present embodiment, an adhesive layer 130 may be selectively formed, and the adhesive layer 130 is already dried and is in the form of a thin film. The adhesive layer 130 is made of, for instance, acrylic-based resin, urethane-based resin, vinyl-based resin, polyester-based resin, polystyrene-based resin, polypropylene-based resin, polyethylene-based resin, or polycarbonate-based resin, and the adhesive layer 130 is configured to enhance the adhesive performance of the decorative film structure 100 (as shown in FIG. 1H).

Since the adhesive layer 130 provided in the present embodiment is optional, it is possible not to form the adhesive layer 130 in other embodiments not shown in the drawings.

With reference to FIG. 1D, a foamed resin layer 110 is formed. Here, the foamed resin layer 110 is formed on the adhesive layer 130. Specifically, the step of forming the foamed resin layer 110 as provided in the present embodiment is described below. With reference to FIG. 1B, a liquid resin layer 110a is forming on the adhesive layer 130. Here, the liquid resin layer 110a is made of polyurethane-based resin, acrylic-based resin, vinyl-based resin, and polyester-based resin.

With reference to FIG. 1C, a foaming process is performed on the liquid resin layer 110a to form a liquid foamed resin layer 110b. Here, the foaming process may include a chemical foaming process or a physical foaming process. In the chemical foaming process, foam is generated by gas produced during the reaction of liquid resin. Alternatively, a reactive blowing agent or a thermal decomposition blowing agent that may produce a significant amount of foam due to heat, is added to the liquid resin layer 110a. The physical foaming process may be performed through mechanical stirring to introduce air into resin, a suspension, or a solution, so as to generate uniform foam.

With reference to FIG. 1D, the liquid foamed resin layer 110b is cured to form the foamed resin layer 110.

With reference to FIG. 1E, a liquid protective resin layer 120a is formed on the foamed resin layer 110. A method of forming the liquid protective resin layer 120a includes spin coating, which should however not be construed as a limitation in the disclosure. Here, the liquid protective resin layer 120a is made of, for example, thermosetting resin or photo-curing resin. The thermosetting resin includes acrylic-based resin, acrylic polyol-based resin, vinyl-based resin, polyester-based resin, epoxy-based resin, and polyurethane-based resin. The photo-curing resin includes a monomer and an oligomer, wherein the monomer may be a mono-functional, difunctional, or poly-functional methacrylate-based monomer, acrylate-based monomer, vinyl-based monomer, vinyl-ether based monomer, and epoxy-based monomer. The oligomer may be an unsaturated polyester-based oligomer, an epoxy acrylate-based oligomer, a polyurethane acrylate-based oligomer, a polyester acrylate-based oligomer, a polyether acrylate based oligomer, an acrylated acrylic oligomer, and epoxy-based resin.

It is worth mentioning that in order to increase the adhesion between the foamed resin layer 110 and the protective resin layer 120 (please refer to FIG. 1G), in other embodiments not illustrated in the drawings, the liquid protective resin layer 120a may be formed on the liquid foamed resin layer 110b before the liquid foamed resin layer 110b is completely cured, which still falls within the protection scope provided herein.

With reference to FIG. 1F, a patterned base material 200 is provided on a surface 122 of the liquid protective resin layer 120a, wherein the surface 122 is in direct contact with the patterned base material 200. For instance, as shown in FIG. 1E, the surface 122 is an upper surface of the liquid protective resin layer 120a relatively far from the foamed resin layer 110, and the surface 112 is substantially a plane surface. The patterned base material 200 has the stereoscopic patterned structure. Since the stereoscopic patterned structure of the patterned base material 200 is in direct contact with the surface 122 of the liquid protective resin layer 120a, the stereoscopic patterns complementary to the patterned structure may be formed on the surface 122. Note that the direct contact described herein refers to the direct contact between the patterned base material 200 and the surface 122 of the liquid protective resin layer 120a through imprinting or lamination.

With reference to FIG. 1F and FIG. 1G, a curing process is performed on the patterned base material 200 and the liquid protective resin layer 120a to cure the liquid protective resin layer 120a and form the protective resin layer 120. According to an embodiment, the curing process includes a thermal curing process or a photo-curing process. In the thermal curing process, for instance, infrared ray or heat wind may be applied to bake the liquid protective resin layer 120a to form the protective resin layer 120, which should however not be construed as a limitation in the disclosure. In the photo-curing process, ultraviolet light may be applied to irradiate the liquid protective resin layer 120a to form the protective resin layer 120a, which should however not be construed as a limitation in the disclosure.

Note that the protective resin layer 120 provided in the embodiment may be colorless or may be colored. For instance, before the liquid protective resin layer 120a is formed on the foamed resin layer 110, a colorant (not shown) may be added to the liquid protective resin layer 120a to provide the protective resin layer 120 formed after curing with different colors, so as to enhance the user's visual experience. In other embodiments, it is possible not to add any colorant to the liquid protective resin layer 120a, whereby the protective resin layer 120 formed after curing is colorless.

With reference to FIG. 1G and FIG. 1H, after the protective resin layer 120 is formed, the patterned base material 200 is removed, and a stereoscopic patterned surface 123 of the protective resin layer 120 is exposed. At this time, the patterns of the stereoscopic patterned surface 123 and the stereoscopic patterned structure of the patterned base material 200 are complementary. Thereby, the protective resin layer 120 may have the special stereoscopic patterned surface 123, so as to ensure the user to have the enhanced visual experience and tactile sensation of the stereoscopic patterns. So far, the decorative film structure 100 is completely formed.

In brief, according to the manufacturing method of the decorative film structure 100 provided in the embodiment, the patterned base material 200 is in direct contact with the surface 122 of the liquid protective resin layer 120a on the foamed resin layer 110, and the curing process is performed on the patterned base material 200 and the liquid protective resin layer 120a to form the protective resin layer 120 with the stereoscopic patterned surface 123. As such, during the manufacture, the patterned base material 200 may be repeatedly used, so as to avoid the production of waste. Besides, the resultant decorative film structure is friendly to environment. Moreover, with use of the patterned base material 200, the required stereoscopic patterned surface 123 may be formed on the protective resin layer 120, so as to simplify the manufacturing process.

Regarding the structure of the present embodiment, the decorative film structure 100 includes the foamed resin layer 110, the protective resin layer 120, and the adhesive layer 130. The protective resin layer 120 is disposed on the foamed resin layer 110 and has the stereoscopic patterned surface 123 relatively far from the foamed resin layer 110. The adhesive layer 130 is disposed on the foamed resin layer 110, and the foamed resin layer 110 is located between the adhesive layer 130 and the protective resin layer 120. As such, the decorative film structure 100 has the softness and flexibility of the foamed resin layer 110 and the visual and tactile sensation of the stereoscopic patterned surface 123 of the protective resin layer 120, so as to ensure the user to have favorable visual and tactile experience.

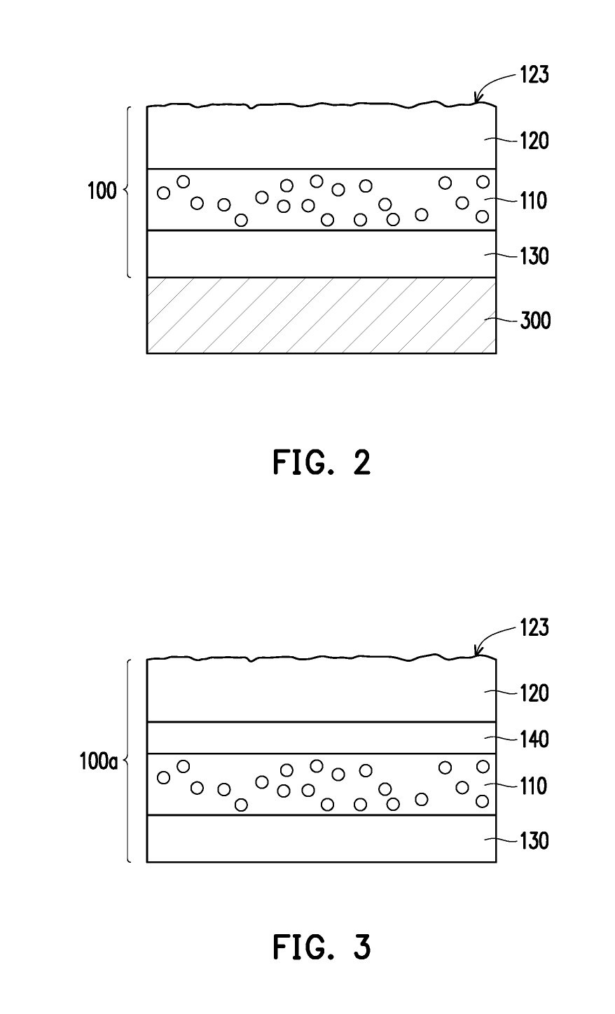

FIG. 2 is a schematic cross-sectional view illustrating adhesion of the decorative film structure depicted in FIG. 1H to a target object. With reference to FIG. 2, in the present embodiment, the decorative film structure 100 may be directly adhered to a target object 300 (e.g., a housing of an electronic apparatus) through the adhesive layer 130 to reinforce the adhesive performance of the decorative film structure 100 through the viscosity of the adhesive layer 130. As such, when the user touches the target object 300 covered by the decorative film structure 100 with the softness and flexibility of the foamed resin layer 110 and the visual and tactile sensation of the stereoscopic patterned surface 123 of the protective resin layer 120, the user is ensured to have favorable tactile experience. Besides, when the user looks at the target object 300 covered by the decoration film structure 100, the user may obtain the special visual experience provided by the decoration film structure 100.

Note that the reference numbers and some contents of the foregoing embodiments are also applied in the following embodiments, in which the same reference numbers are used to designate the same or similar device. Descriptions of the same technical contents may be referred to as those provided above and thus will not be repeated in the following embodiments.

FIG. 3 is a schematic cross-sectional view of a decorative film structure according to another embodiment of the invention. With reference to FIG. 1H and FIG. 3, the decorative film structure 100a provided in the present embodiment is similar to the decorative film structure 100 depicted in FIG. 1H, and the main difference therebetween lies in that the decorative film layer 100a provided in the present embodiment further includes an ink layer 140. Particularly, the ink layer 140 is disposed on the foamed resin layer 110 and located between the foamed resin layer 110 and the protective resin layer 120. Here, the ink layer 140 may be a coating layer which does not allow light to pass through and has color. If the protective resin layer 120 is a colorless film layer, a user is able to observe the color of the ink layer 140 located between the protective resin layer 120 and the foamed resin layer 110 through the protective resin layer 120. Thereby, the user may obtain the enhanced stereoscopic visual experience.

Regarding the manufacturing method of the present embodiment, after the foamed resin layer 110 is formed, as shown in FIG. 1D, the ink layer 140 is formed on the foamed resin layer 110, as shown in FIG. 3. Here, the method of forming the ink layer 140 is intaglio printing or slit coating.

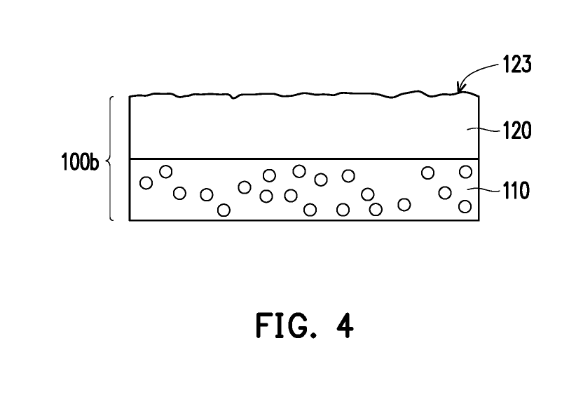

FIG. 4 is a schematic cross-sectional view of a decorative film structure according to still another embodiment of the invention. With reference to FIG. 1H and FIG. 4, the decorative film structure 100b provided in the present embodiment is similar to the decorative film structure 100 depicted in FIG. 1H, and the main difference therebetween lies in that the decorative film layer 100b provided in the present embodiment is not equipped with any adhesive layer. Particularly, in the present embodiment, the decorative film structure 100b includes the foamed resin layer 110 and the protective resin layer 120. The protective resin layer 120 is disposed on the foamed resin layer 110 and has the stereoscopic patterned surface 123 relatively far from the foamed resin layer 110. When the decorative film structure 100b is adhered to a target object (for example, the housing of an electronic apparatus, not shown), the decorative film structure 100b may be pressurized or heated, so that the decorative film structure 100b is reliably adhered to the target object.

To sum up, according to the manufacturing method of the decorative film structure, the patterned base material is in direct contact with the surface of the liquid protective resin layer on the foamed resin layer, and the curing process is performed on the patterned base material and the liquid protective resin layer to form the protective resin layer with the stereoscopic patterned surface. According to the related art, the disposable base material need be removed after the decorative film material is transfer-printed; by contrast, the manufacturing method of the decorative film structure provided herein is simplified, and the production of waste may be avoided. Hence, the decorative film structure provided herein is friendly to environment. Moreover, the decorative film structure formed by applying the manufacturing method described herein is characterized by softness and flexibility with visual and tactile sensation of stereoscopic patterns. The patterned substrate may be repeatedly used and is thus friendly to environment. Besides, the decorative film structure may be directly adhered to the target object (e.g., the housing of an electronic apparatus) through heat or pressure, so as to cover the target object and ensure the target object to have softness, flexibility, and stereoscopic tactile sensation of surface patterns. Last but not least, the decorative film structure provided herein is colored, which is provided by the ink layer or the protective resin layer, so as to enhance the visual sensation for the user.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A decorative film structure comprising:
a foamed resin layer; and
a protective resin layer disposed on the foamed resin layer and having a stereoscopic patterned surface relatively far from the foamed resin layer.

2. The decorative film structure as recited in claim 1, further comprising:
an adhesive layer disposed on the foamed resin layer, wherein the foamed resin layer is located between the adhesive layer and the protective resin layer.

3. The decorative film structure as recited in claim 1, further comprising:
an ink layer disposed on the foamed resin layer and located between the foamed resin layer and the protective resin layer.

4. The decorative film structure as recited in claim 1, wherein the protective resin layer is colorless or is colored.

5. A manufacturing method of a decorative film structure, comprising:
forming a foamed resin layer;
forming a liquid protective resin layer on the foamed resin layer;
providing a patterned base material on a surface of the liquid protective resin layer, wherein the surface of the liquid protective resin layer is in direct contact with the patterned base material;
performing a curing process on the patterned base material and the liquid protective resin layer to cure the liquid protective resin layer and form a protective resin layer; and
removing the patterned base material to expose a stereoscopic patterned surface of the protective resin layer.

6. The manufacturing method of the decorative film structure as recited in claim 5, further comprising:
forming an adhesive layer before forming the foamed resin layer.

7. The manufacturing method of the decorative film structure as recited in claim 6, the step of forming the foamed resin layer comprising:
forming a liquid resin layer on the adhesive layer;
performing a foaming process on the liquid resin layer to form a liquid foamed resin layer; and
curing the liquid foamed resin layer to form the foamed resin layer.

8. The manufacturing method of the decorative film structure as recited in claim 7, wherein the foaming process comprises a chemical foaming process or a physical foaming process.

9. The manufacturing method of the decorative film structure as recited in claim 5, wherein the curing process comprises a thermal curing process or a photo-curing process.

10. The manufacturing method of the decorative film structure as recited in claim 5, further comprising:
forming an ink layer on the foamed resin layer after forming the foamed resin layer but before forming the liquid protective resin layer.
